(19) United States
(12) Patent Application Publication
(10) Pub. No.: US 2026/0126340 A1
(43) Pub. Date: May 7, 2026

(54) SYSTEM FOR ROUTING OBJECTS COMPRISING REUSABLE CONTAINERS

(71) Applicant: PA.COTTE SA, Pully (CH)

(72) Inventors: Pierre-Alain Cotte, Amberg (DE); Jérôme Colin, Sainte Luce sur Loire (FR)

(73) Assignee: PA.COTTE SA, Pully (CH)

(21) Appl. No.: 19/104,895

(22) PCT Filed: Aug. 17, 2023
(86) PCT No.: PCT/EP2023/072750

§ 371 Date: Feb. 19, 2025

(30) Foreign Application Priority Data
Aug. 22, 2022 (FR) FR2208443
Aug. 14, 2023 (FR) FR2308715

(51) Int. Cl. G01M 7/00; B65D 79/02

(52) U.S. Cl. CPC G01M 7/00; B65D 79/02

(57) ABSTRACT

The invention relates to a subsystem for assessing the wear of a mechanical element comprising:
a vibration sensor connected to electronic processing means and coupled to the mechanical element,
a vibration generator intended to produce vibrations transmitted to said mechanical element, the generator being parameterized to produce a vibration sequence,
the electronic processing means are programmed with at least one reference vibration profile of the mechanical element, and are parameterized to:
   trigger the vibration generator;
   analyze vibrations produced by the vibration generator and captured by the vibration sensor to determine a captured vibration profile of the mechanical element;
   issue a notification relating to a degradation of the captured vibration profile.

### FIELD OF THE INVENTION

The field of the invention is that of logistics.

The invention more particularly relates to a system and a method for conveying objects implementing reusable containers intended to contain the objects.

### STATE OF THE ART

Conventionally, deliveries of objects involve the use of a container intended to contain the object, and to form a protective shell around this object.

Cardboards form such containers in the simplest way. These cardboards are not, or very little, capable of supporting deliveries other than the first one. Indeed, the cardboards tear or deform in a non-elastic manner in the event of too great an impact, or careless handling.

Reusable boxes are increasingly used for conveying objects. These reusable boxes are designed in materials that are more robust than cardboard. For example, such reusable boxes can be made from reinforced plastic, such as expanded polystyrene, which has a much greater durability than cardboard.

These reusable boxes can be provided with embedded electronics and, for example, an outer screen for displaying, if necessary, delivery information on the outside of the container. This avoids the use of self-adhesive labels to be printed for each delivery of a parcel formed by one of the reusable boxes.

This technique makes it possible to form parcels whose container (the box) used for the delivery is not intended to be thrown away following the first delivery.

However, the very nature of a delivery causes these reusable boxes to be subjected to impacts and potentially destructive handling. Thus, despite significant durability sought, a degradation of these reusable boxes is inevitable.

Various components of these boxes can therefore be damaged and weakened.

The walls of these boxes can for example break, split, crack or deform. In this case, the boxes are made difficult to use, or even completely unusable. Indeed, during a delivery, the content of the box can then be damaged or even lost.

A degradation of a wall of these reusable boxes thus makes it impossible to reuse these boxes as containers for the deliveries.

Consequently, a periodic inspection of the state of these reusable boxes must be conducted to prevent a degraded box from being reused.

Given the large number of reusable boxes that can be implemented as part of a system for conveying objects, the inspection of each of these reusable boxes can become problematic.

This checking of the wear of a box conventionally requires a human operator. This human operator can for example correspond to the person who has just received a reusable box, who can then observe and check the state of the reusable box before returning this reusable box.

Such checking may not be sufficient and is inherently subjective. Wear thus may not be detected.

### OBJECTIVES OF THE INVENTION

The invention aims in particular to address this issue.

More specifically, the invention aims to propose a subsystem for assessing the wear of a physical element of a device into which it is integrated.

The invention also aims to provide reusable containers integrating a wear assessment subsystem according to the invention.

The invention also aims to propose a system for conveying objects implementing reusable containers whose wear can be easily checked, despite a large number of reusable containers.

The invention also aims to provide such a system that allows making the detection of wear more reliable during a checking of the reusable container.

### DISCLOSURE OF THE INVENTION

These objectives, as well as others that will appear subsequently, are achieved thanks to the invention which relates to a subsystem for assessing the wear of at least one physical element constituting a device into which said subsystem is integrated, said subsystem comprising at least one vibration sensor connected to electronic processing means and coupled to the physical element, the subsystem also comprising:
at least one vibration generator intended to produce vibrations transmitted to said physical element, the generator being parameterized to produce a vibration sequence with at least one predetermined frequency and at least one predetermined amplitude, and the electronic processing means are programmed with at least one reference vibration profile of the physical element, and are parameterized to:
periodically trigger the vibration generator, or automatically after the detection of a predetermined event detected by at least one sensor connected to the electronic processing means, or trigger the vibration generator by a one-time request to activate the wear assessment subsystem;
analyze vibrations produced by the vibration generator and captured by the vibration sensor to determine a captured vibration profile of the physical element;
issue a notification relating to a degradation of the captured vibration profile compared to the at least one reference vibration profile of the physical element.

In other words, the electronic processing means are programmed to, substantially in parallel, on the one hand trigger the production of a series of vibrations or vibration profile transmitted to the physical element and on the other hand capture directly or indirectly the vibrations produced, retransmitted by and therefore through the physical element.

Thanks to these technical characteristics, the wear assessment subsystem that integrates its own vibration generator produces a reference vibration profile it submits directly or indirectly to the monitored physical element. Thus, for the analysis, the source of the vibrations is perfectly controlled and the vibrations generated are reproducible. The comparison of the captured vibration data forming the vibration profile to be analyzed with the reference vibration profile then makes it possible to follow the evolution of the aging of the physical element.

Furthermore, the wear assessment subsystem has the advantage of autonomously ensuring the monitoring of the physical element under observation and enabling self-diagnosis.

According to one preferred embodiment of the invention, the or one of the reference vibration profiles of the physical element corresponds to a vibration profile of the physical element in new state, or in repaired state, or in transient state determined by vibration analysis at a predetermined instant.

According to another solution, the or one of the reference vibration profiles of the physical element corresponds to an aggregate of vibration profiles of physical elements previously analyzed by the electronic processing means.

According to one particularly advantageous embodiment of the invention, the vibration generator and/or the vibration sensor are directly coupled to the physical element. In other words, the vibration generator and/or sensor is in direct contact and therefore has a common interface with the physical element to be observed. This is what allows obtaining the vibration signature of said physical element during the lifetime of the product into which it is integrated.

Thanks to these characteristics, only the response to the vibration profile of the physical element integrated into the device is analyzed. It is thus possible to accurately determine the maintenance, repair or replacement of the physical element concerned, when a wear threshold is crossed, unlike an indirect coupling that provides the vibration response of an assembly of elements or mechanism in which the identification of the fatigued physical element remains to be done.

According to one particular embodiment of the invention, the vibration sensor is chosen from a group comprising an accelerometer, a velocimeter, a displacement sensor, a resistive strain gauge.

According to one embodiment, the invention also provides a reusable container intended to contain objects, forming the device that comprises the physical element and the wear assessment subsystem.

Thus, a device of the container type that includes, permanently, the entire wear assessment subsystem according to the invention, can throughout its lifetime assess at any time and as needed, the level of wear of the monitored physical element.

According to one preferred embodiment of the invention, the one-time request to activate the wear assessment subsystem is issued when the container is in a reference situation.

Thanks to these characteristics, the acquisition of a new checking, observation or monitoring vibration profile can be carried out under conditions similar to those in which a reference vibration profile of the monitored physical element was acquired. For example, the reference situation is that of the device equipped with the monitored physical element, the assembly being unused and at rest. A calibration can for example take place at the output of the production line of the device equipped with the wear assessment subsystem, by acquiring the reference vibration profile in new state, as described below. Thus, the reference vibration profile is specific to the physical element under observation. The follow-up of the aging is therefore personalized and specific to the physical element under observation. In other words, the acquisition of a new vibration profile on request in a situation similar to the reference one, that is to say to a known and substantially reproducible situation, makes the comparative analysis of the vibration profiles and the diagnosis of fatigue or wear of the physical element of the device thus equipped more reliable.

It is understood that the reference situation can be defined according to other criteria. For example, for a container, the reference situation can be that of a container not empty, but with a determined load placed in the container. This determined load being chosen so as to highlight a particular characteristic of the container using the vibration profile that is recorded and analyzed.

According to one advantageous embodiment of the invention, the physical element to which the vibration generator is coupled is a wall of said container.

According to one particularly advantageous embodiment of the invention, the container comprises a display device intended to be visible to a user of the system, and in that the electronic processing means are parameterized to display on the display device the notification relating to a degradation of the captured vibration profile, said notification being issued by the wear assessment subsystem.

Thus, the device that integrates the wear assessment subsystem, here the container, can inform the user of its state and its degradation.

According to one embodiment, the invention also provides a preventive maintenance system comprising wear assessment subsystems, a remote server and, for each subsystem, means of communication with the remote server which is parameterized to record the notification relating to the degradation of the captured vibration profile by each wear assessment subsystem.

Thanks to these technical characteristics, each wear assessment subsystem is supervised and the history of the notifications of the degradation of the vibration profile of the monitored physical element is stored.

Furthermore, the aggregation of the vibration profiles of several wear assessment subsystems coupled to physical elements of the same types makes it possible to cross-reference the history of the aging and degradation information of said elements so as to facilitate the set-up of a preventive maintenance strategy, anticipating breakdowns and shutdowns.

According to one particular embodiment of the invention, each wear assessment subsystem is integrated into a container forming a fleet of reusable object conveying containers, supervised by the preventive maintenance system.

Thanks to these technical characteristics, the wear of a fleet of containers is being monitored, for preventive maintenance purposes.

According to one embodiment, the invention also provides a method for assessing the wear of at least one physical element constituting a device integrating a wear assessment subsystem that implements the method, the wear assessment subsystem comprising:
at least one vibration sensor connected to electronic processing means and coupled to the physical element;
at least one vibration generator intended to produce vibrations transmitted to said physical element, the generator being parameterized to produce a vibration sequence with at least one predetermined frequency and at least one predetermined amplitude, the electronic processing means being programmed with at least one reference vibration profile of the physical element,
   the method comprising the steps of:
periodically triggering the vibration generator, or automatically after the detection of a predetermined event detected by at least one sensor connected to the electronic processing means, or triggering the vibration generator by a one-time request to activate the wear assessment subsystem;
analyzing vibrations produced by the vibration generator and captured by the vibration sensor to determine a captured vibration profile of the physical element;
issuing a notification relating to a degradation of the captured vibration profile compared to the at least one reference vibration profile of the physical element.

Moreover, the invention also relates to a system for conveying objects comprising:
reusable containers intended to contain objects;
at least one accelerometer per container;
electronic processing means;
   characterized in that it comprises a subsystem for assessing the wear of the reusable containers comprising:
at least one vibration generator intended to produce vibrations in at least one wall of at least one of the reusable containers, the generator being parameterized to produce a vibration sequence with at least one predetermined frequency and at least one predetermined amplitude,
   and in that, for each container, the electronic processing means are programmed with at least one reference vibration profile of the container, and are parameterized to:
analyze vibrations produced by the vibration generator and captured by the accelerometer to determine a captured vibration profile of the container;
issue a notification relating to a degradation of the captured vibration profile compared to the at least one reference vibration profile of the container.

Thanks to the object conveying system according to the invention, a reusable container can get its wear assessed using a vibration sequence produced by the vibration generator and thanks to the capture of these vibrations by the accelerometer of said reusable container and the analysis of these vibrations.

The wear of a container corresponds for example to a weakening, a fracturing, a degradation, or a breakage of the container.

The analysis of the vibrations produced makes it possible to compare the captured vibration profile with the reference vibration profile.

This captured vibration profile, compared to the reference vibration profile, makes it possible to determine a level of degradation of the vibration profile and to know whether a predetermined level of degradation is reached or exceeded or even to know the location of the degradation on the container.

This wear assessment of the reusable containers is carried out without necessarily involving an operator, intended for example to carry out a visual inspection of the container. Preventive, for example automated, maintenance of the containers of the system is possible.

Thanks to an analysis of the captured vibration profile compared to a reference vibration profile, the detection of visually undetectable wear can be detected to avoid the usage of a container that would in reality be unsuitable for carrying out a conveying of objects.

According to one preferred variant, the reusable containers are reusable parcel boxes which each comprise at least one accelerometer.

In this case, the reference vibration profile of the container corresponds to a reference vibration profile of the reusable box.

Such an application of the system according to the invention to containers of the “reusable parcel box” type is particularly advantageous in that these boxes undergo potentially destructive handling during their transport for delivery, and in that it is then important to be able to check their ability to be reused.

According to one preferred embodiment, each container integrates at least one vibration generator, the electronic processing means being configured to actuate the vibration generator(s).

In this way, a checking of the structural integrity of a container can be carried out autonomously, even when the container is used to make a delivery or is waiting to be used to make a delivery. In this case, the electronic processing means actuate the vibration generator(s) integrated into the container, capture vibrations using the accelerometer integrated into the container, then analyze the vibrations.

Alternatively or additionally, the system comprises an outer vibration generator, distinct from the reusable boxes.

Such an outer generator can be used by a human operator, or by an automaton, intended to bring said generator into contact with a wall of a box to be checked.

Preferably, the system comprises, for each container, a computer unit forming at least partially the electronic processing means.

This makes it possible to conduct an analysis of the vibrations produced by the vibration generator directly using the computer unit of the container.

The computer unit can then issue the notification relating to the captured vibration profile alone and, if necessary, shut down if the wear of the container is too great or request a return for maintenance.

According to one preferred design, the computer unit is integrated into the container, and preferably into one of the walls of the container.

The integration of the computer unit with the container is then optimized.

According to another preferred design, the computer unit is added onto the container, the system comprising means for coupling the computer unit to a container.

In other words, coupling means ensure the integration and mechanical connection of the computer unit added onto the container.

This makes it possible to use computer units with different types of containers, and potentially containers that are not initially designed to form part of the system according to the invention.

Advantageously, the system comprises a remote server, and means of communication with the remote server for each container, the remote server being parameterized to record the notification relating to the degradation of the captured vibration profile.

In this way, the remote server groups together the notifications relating to the degradation of the captured vibration profile of the containers of the system.

This avoids having to return and consult each container of the system to become aware of a degradation of the containers.

The remote server can be advantageously parameterized so that, upon receipt of a notification relating to the degradation of the captured vibration profile of a container, it programs preventive maintenance of said container.

The system then greatly simplifies the operations of maintaining the containers.

Advantageously, the remote server can form at least partially the electronic processing means.

In this case, the analysis of the vibrations, produced by the vibration generator and captured by the accelerometer, to determine a captured vibration profile of the container, can be carried out by electronic means more powerful than those of the computer unit of a container.

The communication means for each container are designed to transmit to the remote server the data relating to the vibrations captured by the accelerometer so that the remote server analyzes these vibrations.

According to one preferred solution, the generator is parameterized to produce at least two vibration sequences with at least two different predetermined frequencies and/or at least two different predetermined amplitudes.

A plurality of vibration sequences makes it possible to improve the detection of possible structural defects of a container.

According to one advantageous solution, the or one of the reference vibration profiles of the container corresponds to a vibration profile of the container in new state, or in repaired state, or in transient state determined by vibration analysis at a predetermined instant.

The vibration profile of the container in new state corresponds to the vibrations captured by the accelerometer of the container following the emission of vibrations by a vibration generator of the system after the design and manufacture of the container. Such a reference vibration profile makes it possible to accurately calibrate the original level of the vibration profile.

The vibration profile of the container in transient state corresponds to the vibrations captured by the accelerometer of the container following the emission of vibrations by a vibration generator of the system at a predetermined instant, for example automatically or on request of the remote server after use of the container.

According to another solution, the or one of the reference vibration profiles of the container corresponds to an aggregate of vibration profiles of containers previously analyzed by the electronic processing means.

The system then implements artificial intelligence for analyzing such a data stream. Such a method makes it possible to enrich, through the experience of the artificial intelligence and observations of degradation, the reference vibration profile.

Advantageously, the electronic processing means are parameterized to periodically trigger the vibration generator, or automatically after the detection of a predetermined event detected by at least one sensor of the container.

A periodic checking of the structural state of a container can thus be carried out and the evolution of wear can be noted to allow the most accurate programming of maintenance of the degraded container.

A predetermined event can correspond to a fall of the container, or to a significant impact. The detection of such an event can for example be carried out using the accelerometer. Carrying out a checking following such a predetermined event is particularly advantageous in that it makes it possible to know directly whether this predetermined event has caused degradation likely to make the container unusable.

According to one advantageous characteristic, the system comprises a display device intended to be visible to a user of the system, and the electronic processing means are parameterized to display on the display device the notification relating to a degradation of the captured vibration profile.

In this way, the system allows a user of the system to become directly aware of a degradation observed in a container, and this without delay.

The invention also relates to a method for conveying objects comprising reusable containers intended to contain objects and each comprising an accelerometer, characterized in that it comprises a step of assessing the wear of the reusable containers implementing, during the assessment of the wear of one of the containers:
a production of a vibration sequence with predetermined frequency and amplitude, in a wall of one of the reusable containers;
a capture of the vibrations propagating in the wall of the container by the accelerometer;
an analysis of the captured vibrations.

Preventive maintenance of the reusable containers, for conveying other objects, is then possible, for example by programming a shipment to a repair center.

### FIGURES

Other characteristics and advantages of the invention will become more clearly apparent upon reading the following description of various preferred embodiments of the invention, given as illustrative and non-limiting examples, and the appended figures:

FIG. 1 is a schematic representation of a first embodiment of a system for conveying objects according to the invention, comprising a reusable container of the reusable parcel box type;

FIG. 2 is a schematic representation of a second embodiment of the object conveying system according to the invention, comprising any container.

### DETAILED DESCRIPTION OF THE INVENTION

The subsystem for assessing the wear of at least one physical element according to the invention is intended to be integrated into a device that includes the physical element to be monitored. Thus, such a wear assessment subsystem is a subassembly embedded in a third-party device. One example of a third-party device is described below with a reusable container 1 embedding such a wear assessment subsystem.

According to the invention, such a subsystem comprises:
at least one vibration sensor 11 physically coupled, directly or indirectly, to the physical element to be observed,
at least one vibration generator 3 intended to produce vibrations transmitted, directly or indirectly, to the physical element of the support device,

Furthermore, this vibration sensor 11 is connected, so as to communicate, to electronic processing means 2. As will be seen later in this description, the electronic processing means 2 are programmed with at least one reference vibration profile of the physical element, and are parameterized to:
periodically trigger the vibration generator 3, or automatically after the detection of a predetermined event detected by at least one sensor connected to the electronic processing means 2, or trigger the vibration generator 3 by a one-time request to activate the wear assessment subsystem;
analyze vibrations produced by the vibration generator 3 and captured by the vibration sensor 11 to determine a captured vibration profile of the physical element;
issue a notification relating to a degradation of the captured vibration profile compared to the at least one reference vibration profile of the physical element.

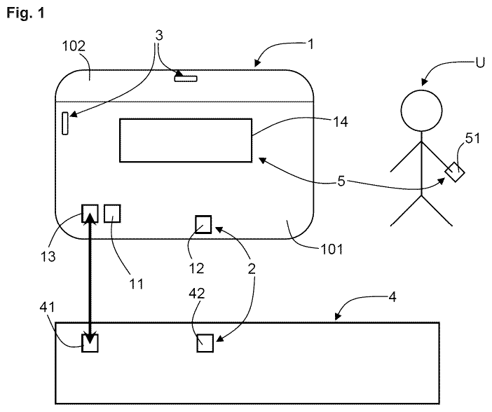

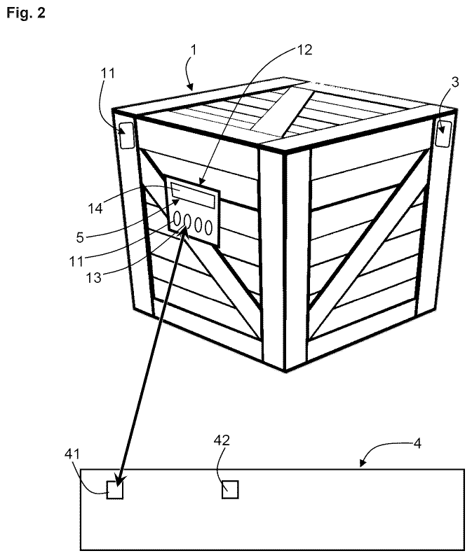

In FIGS. 1 and 2, the wear assessment subsystem is represented perfectly integrated to the device and system described below, in which all of the containers of the system form a conveying fleet within the meaning of the invention.

Thus, the object conveying system according to the invention, represented in FIG. 1, implements a method for conveying objects according to the invention.

With reference to FIGS. 1 and 2, the object conveying system comprises:
reusable containers 1;
electronic processing means 2.

The system also comprises a remote server 4.

According to the embodiment illustrated by FIG. 1, the reusable containers 1 are reusable parcel boxes. These boxes can be used to send objects in the form of parcels.

With reference to FIG. 2, the container 1 represented is a transport case.

According to the principle of the invention with reference to FIGS. 1 and 2, the system also comprises a subsystem for assessing the wear of the reusable containers 1.

This assessment subsystem comprises at least one vibration generator 3 intended to produce vibrations in a wall of at least one of the reusable containers 1. This or these generators 3 are designed to produce at least one vibration sequence with at least one predetermined frequency and at least one predetermined amplitude.

According to the embodiment represented in FIG. 1, the assessment subsystem comprises at least one vibration generator 3 integrated into each container 1.

More specifically, each container 1 comprises two vibration generators 3.

According to the embodiment represented in FIG. 2, the assessment subsystem comprises a single vibration generator 3 integrated into the container 1.

According to one conceivable embodiment, the vibration generator 3 is an outer generator and is distinct from the reusable containers 1. This outer generator is intended to be affixed to the surface of a wall of one of the containers 1 to produce a vibration sequence with predetermined frequency and amplitude.

According to another conceivable embodiment, it is possible for the system to comprise vibration generators 3 integrated into each container 1, as well as outer vibration generators 3.

With reference to FIG. 1, each reusable container 1, of the parcel box type, consists of a case 101 and a lid 102 movably mounted on the case 101 between a closed position of the case 101 and an open position allowing access to an internal volume delimited by the case 101 and, possibly, to an object that the reusable box contains. More particularly, the internal volume of the case 101 is delimited by a bottom wall and several side walls extending from the bottom wall, the side walls abutting each other to form a peripheral contour of the internal volume.

The lid 102 is in this case pivotally mounted on the case 101.

A vibration generator 3 is integrated into one of the walls of the case 101 of the illustrated reusable box, and another vibration generator 3 is integrated into the wall of the lid 102 of the reusable box.

The use of at least two vibration generators 3 makes it possible to multiply the locations of generation of vibrations in the walls of a reusable container 1.

A vibration generator 3 can take different forms.

A vibration generator 3 can for example be formed by a weight, or a vibrating element such as an unbalanced propeller.

It is also conceivable that a vibration generator 3 is formed by a vibrating surface (for example the membrane of a loudspeaker) or by an ultrasound generator.

These generators 3 are parameterized to produce said at least one vibration sequence with predetermined frequency and amplitude. Advantageously, at least two vibration sequences with distinct predetermined frequencies and amplitudes are produced.

A vibration sequence can comprise a single frequency or a plurality of frequencies, the frequency of the vibrations changing as the sequence progresses, and a single amplitude or a plurality of amplitudes, the amplitude of the vibrations changing as the sequence progresses.

With reference to FIGS. 1 and 2, the system comprises for each container 1:
at least one accelerometer 11;
a computer unit 12;
means of communication 13 with the remote server 4;
a screen 14;
electric accumulators intended to store electrical energy and to power the electronic functions of each container 1, including in particular the accelerometer 11, the computer unit 12, the communication means 13, and the screen 14.

The accelerometer 11 is designed, among other things, to capture vibrations produced by the generator(s) 3 and propagating in the walls of the container 1.

The screen 14 is located on an outer face of the reusable container 1 and is intended to be visible from the outside.

Such a screen 14 is for example capable of displaying usage information of the reusable container 1, such as a destination address of the container 1.

More generally, the system comprises a display device 5 intended to be visible to a user U of the system.

This display device 5 can for example be formed by the screen 14 of each container 1.

With reference to FIG. 1, the display device 5 can also be formed, alternatively or complementary to the screen 14, by an electronic device 51 of the user U such as a Smartphone.

As illustrated in FIGS. 1 and 2, the remote server comprises data exchange means 41 and an electronic processing member 42.

The data exchange means 41 of the remote server 4 are designed to allow the receipt and sending of data from and to each container 1 via the communication means 13.

According to one embodiment, electronic processing means 2 are formed by the computer unit 12 of each container 1.

According to another embodiment conceived, the electronic processing means 2 are formed by the electronic processing member 42 of the remote server 4.

Finally, according to the embodiment of FIG. 1, the electronic processing means 2 are partially formed by the computer unit 12 of each container 1 as well as by the electronic processing member 42 of the remote server 4.

With reference to FIG. 1, the computer unit 12 is integrated into the container 1, and more particularly into one of the walls of the container 1.

More specifically, the container 1 is designed to have a housing in one of its walls which is complementary in shape to the computer unit 12.

With reference to FIG. 2, the computer unit 12 is added onto the container 1. The system then comprises means for coupling the computer unit 12 to the container 1.

The computer unit 12 may take the form of an electronic tablet.

The coupling means may take the form of an adhesive, and/or fixing tabs, and/or screws, and/or any other means capable of allowing the coupling of the computer unit 12 to a container 1.

According to the embodiments of FIGS. 1 and 2, the vibration generators 3 are integrated into the containers 1 but are distinct from the computer units 12.

The vibration generators 3 are then connected to the computer units 12 via a wired connection or a wireless connection. These generators 3 can be provided with their own power supply means and are either integrated into one of the walls of the container 1 or fixed to one of the walls of the container 1.

It is conceivable that a vibration generator 3 is integrated into a computer unit 12.

In a comparable manner, the accelerometers 11 can be integrated into the containers 1 in the computer unit 12 and/or out of the computer unit 12.

With reference to FIG. 1, a single accelerometer is integrated into the container 1 out of the computer unit 12.

According to another conceivable embodiment, this single accelerometer 11 can however be integrated into the computer unit 12.

With reference to FIG. 2, two accelerometers 11 are integrated into the container 1, one out of the computer unit 12 and another in the computer unit 12.

In the case where an accelerometer is integrated out of the computer unit 12, this accelerometer 11 is connected to the computer unit 12 via a wired connection or a wireless connection. This accelerometer can be provided with its own power supply means. Finally, the accelerometer is then either integrated into one of the walls of the container 1, or fixed to one of the walls of the container 1.

According to the principle of the invention, for each container 1, the electronic processing means 2 are programmed with at least one reference vibration profile of the container 1.

This reference vibration profile can for example correspond to the vibration profile of a new model of the container 1.

The reference vibration profile can also correspond to a repaired state of the container 1, or to a transient state determined by vibration analysis at a predetermined instant.

This predetermined instant can correspond to the occurrence of an event occurring on the container 1 and captured by a sensor of the container 1, such as the accelerometer 11. For example, a fall of the container 1, followed by an impact of the container 1, may be captured by the accelerometer 11.

The reference vibration profile can also correspond to an analysis by artificial intelligence of an aggregate of previously analyzed vibration profiles of containers 1. In this case, it is advantageous for the container 1 to have a standardized design and format such as is the case for the container 1 of the embodiment of FIG. 1 which is a reusable parcel parcel.

The reference vibration profile(s) are advantageously established when the container 1 is empty.

For this purpose, the system is configured to detect, for example using the weight sensor or a camera located in the container 1, that the container 1 is empty, to authorize the establishment of a reference vibration profile.

The reference vibration profile(s) can also be established following the loading of the container 1 and its closing.

The electronic processing means 2 are parameterized to:
analyze the vibrations produced by the vibration generator(s) 3, and captured by the accelerometer 11, to determine a captured vibration profile of the container 1;
issue a notification relating to a degradation of the captured vibration profile compared to the reference vibration profile of the container 1.

Of course, the issuing of the notification relating to the degradation of the captured vibration profile compared to the reference vibration profile involves an analysis of the captured vibration profile compared to the reference vibration profile. The observation of a degradation of the captured vibration profile may lead to the issuing of the notification from a predetermined degree of degradation below which a degradation is not invalidating.

The analysis can be carried out in such a way that the gap between the reference vibration profile and the captured vibration profile is used to determine the type of wear, the severity and the location on the container 1.

As mentioned above, each container 1 can communicate with the remote server 4.

In this way, the remote server 4 receives the notification relating to the degradation of the captured vibration profile compared to the reference vibration profile of the container 1.

This remote server 4 is parameterized to record this notification.

In the case where the analysis is conducted by the electronic processing members 42 of the remote server 4, then the notification is issued towards the container 1.

Advantageously, the remote server 4 is parameterized to program preventive maintenance of the container 1 upon receipt of a notification relating to excessive degradation of the captured vibration profile compared to the reference vibration profile.

Preventive maintenance of the container 1 can only be recorded and programmed in the remote server 4 which, associated with an identifier of the too degraded container 1, causes maintenance of the container 1 as soon as the latter arrives at a location where it is likely to be repaired, or at least removed from the object conveying circuits.

Advantageously, the remote server 4 is parameterized to return maintenance requirement information to the container 1.

Upon receipt of this maintenance requirement information, the electronic processing means 2 of the system are programmed to place the container 1 in a non-use configuration.

In this case, the electronic processing means 2 inform, for example via the screen 14, the users U of the inability of the container 1 to convey an object, and display on the screen 14 of the container 1 a destination address of a maintenance center of the container 1.

The container 1 can thus be sent for maintenance in the maintenance center.

Advantageously, the electronic processing means 2 are parameterized to periodically trigger the vibration generator 3.

In this way, a periodic verification of the integrity of the reusable container 1 is implemented.

The triggering periodicity of the vibration generator 3 may be:
significantly spaced in time if a slight degradation compared to a new state of the vibration profile of the container 1 is recorded;
close in time as soon as an increasingly significant degradation of the captured vibration profile is detected compared to the reference vibration profile.

The electronic processing means 2 may also occasionally require an activation of the wear assessment subsystem, and trigger the vibration generator 3.

This activation may result from a command or request, from the remote server 4, from an action performed on the container 1, or result from an automation whose trigger may for example be an impact detected on the container 1 by a sensor of the container 1, such as the accelerometer 11.

The electronic processing means 2 may also require an activation of the wear assessment subsystem following the request to make a delivery using the container 1, or following the closing of the container 1 after a delivery, so as to ensure that the container 1 is able to make a delivery.

The electronic processing means 2 may also require an activation of the wear assessment subsystem following the detection of a predetermined event detected by at least one sensor of the container 1. Following this assessment, if the container 1 is considered able to continue the deliveries, it is conceivable that a new reference vibration profile is established as mentioned above.

In this way, it is easier to determine, as accurately as possible, as soon as the degradation threshold invalidating the usage of the reusable container 1 is reached or exceeded.

As a reminder, the system comprises a display device 5 intended to be visible to a user U of the system.

The electronic processing means 2 are parameterized to display on the display device 5 the notification relating to a degradation of the captured vibration profile.

The conveying method according to the invention implements reusable containers 1 intended to contain objects and each comprising at least one accelerometer 11.

This method comprises a step of assessing the wear of the reusable containers.

The step of assessing a wear of the reusable containers comprises, during the assessment of the wear of one of the containers:
a production of a vibration sequence with predetermined frequency and amplitude, in a wall of one of the reusable containers;
a capture of the vibrations propagating in the wall of the container by the accelerometer;
an analysis of the captured vibrations.

The production of a vibration sequence with predetermined frequency and amplitude is carried out by the vibration generator 3.

Advantageously, this production of a vibration sequence is performed directly in a wall of the container 1 because the vibration generator 3 is integrated directly into the container 1 and more specifically on or in the wall of one of the containers 1.

As explained above, this production of a vibration sequence with predetermined frequency and amplitude can also give rise to the production of other vibration sequences with other predetermined frequencies and amplitudes.

The capture of the vibrations propagating in the wall(s) of the container 1 by the accelerometer 11 makes it possible to capture the frequency and the amplitude of the vibrations after they have propagated in the wall.

This capture of the vibrations makes it possible to determine a captured vibration profile.

Then, the analysis of the captured vibrations makes it possible to determine whether a degradation of the container 1 has occurred.

This analysis implements algorithms making it possible to determine whether or not the container 1 has reached or crossed a too great degradation threshold. Advantageously, this analysis is also carried out to provide information on the type of degradation, its severity, and its location.

This analysis of the captured vibrations, and thus of the captured vibration profile, is carried out compared to the reference vibration profile.

The step of assessing a wear of the reusable boxes can also implement, subsequently to the analysis of the vibrations captured, a recording and an issuing of a notification relating to a degradation of the captured vibration profile compared to the reference vibration profile of the container 1.

The object conveying system according to the invention thus implements reusable boxes that can themselves, at any time, following an impact or a triggering event or on demand, easily check their state of mechanical wear.

Also, preventive maintenance can be programmed as soon as possible upon detection of a serious defect, remotely and on demand.

In variants of the embodiments of the invention detailed above, it may also be provided to use other types of vibration detector than the accelerometer, that is to say any recorder of the transmission of a mechanical vibration.

Nevertheless, by accelerometer, it should be understood any type known to those skilled in the art and in particular the piezoelectric accelerometers, the piezoresitive accelerometers, the fiber optic accelerometers, the torque-balanced or force-balanced servo-controlled accelerometers, the resonator accelerometers, the capacitive micro-electromechanical system accelerometers known as MEMS.

The vibration detector can also be a velocimeter. In this case, it is of course necessary to include the electrodynamic velocimeters, the laser velocimeters also known as vibrometers, the ultrasonic velocimeters.

The vibration detector can also be a displacement sensor. This comprises all types of displacement sensors and in particular the inductive displacement sensors, the capacitive displacement sensors, the optical displacement sensors (particularly by interferometry, laser triangulation, reflection or transmission), the differential transformer displacement sensors, the taut-wire displacement sensors of the potentiometer or encoder type.

The technique described above to make a subsystem for assessing the wear of at least one physical element can be used in different types of fixed or on-board devices, for example to constitute a parcel, a packet or luggage such as a trunk or a suitcase.

Moreover, the term physical element should be understood in the broad sense to encompass a mechanical part, a mechanism or mechanical subassembly, or an electronic card.

1.-25. (canceled)

26. A system for conveying objects comprising:
reusable containers intended to contain objects;
at least one accelerometer per container;
electronic processing means;
characterized in that it comprises a subsystem for assessing the wear of the reusable containers comprising:
at least one vibration generator intended to produce vibrations in at least one wall of at least one of the reusable containers, the generator being parameterized to produce a vibration sequence with at least one predetermined frequency and at least one predetermined amplitude,
and in that each container integrates at least one of the vibration generators,
and in that, for each container, the electronic processing means are programmed with at least one reference vibration profile of the container, and are parameterized to:
periodically trigger the vibration generator, or automatically after the detection of a predetermined event detected by at least one sensor of the container, or trigger the vibration generator by a one-time request to activate the wear assessment subsystem;
analyze vibrations produced by the vibration generator and captured by the accelerometer to determine a captured vibration profile of the container;
issue a notification relating to a degradation of the captured vibration profile compared to the at least one reference vibration profile of the container.

27. The object conveying system according to claim 26, characterized in that the reusable containers are reusable parcel boxes which each comprise at least one accelerometer.

28. The system according to claim 26, characterized in that the system comprises, for each container, a computer unit forming at least partially the electronic processing means.

29. The system according to claim 28, characterized in that the computer unit is integrated into the container, and preferably into one of the walls of the container.

30. The system according to claim 29, characterized in that the computer unit is added onto the container, the system comprising means for coupling the computer unit to a container.

31. The system according to claim 26, characterized in that it comprises a remote server, and means of communication with the remote server for each container, the remote server being parameterized to record the notification relating to the degradation of the captured vibration profile.

32. The system according to claim 26, characterized in that the generator is parameterized to produce at least two vibration sequences with at least two different predetermined frequencies and/or at least two different predetermined amplitudes.

33. The system according to claim 26, characterized in that the or one of the reference vibration profiles of the container corresponds to a vibration profile of the container in new state, or in repaired state, or in transient state determined by vibration analysis at a predetermined instant.

34. The system according to claim 26, characterized in that the or one of the reference vibration profiles of the container corresponds to an aggregate of vibration profiles of containers previously analyzed by the electronic processing means.

35. The system according to claim 26, characterized in that it comprises a display device intended to be visible to a user of the system, and in that the electronic processing means are parameterized to display on the display device the notification relating to a degradation of the captured vibration profile.

36. A method for conveying objects implementing reusable containers intended to contain objects and each comprising an accelerometer, and each integrating at least one vibration generator intended to produce vibrations in at least one wall of at least one of the reusable containers;
a subsystem for assessing the wear of the reusable containers;
electronic processing means parameterized to periodically trigger the vibration generator, or automatically after the detection of a predetermined event detected by at least one sensor of the container, or to trigger the vibration generator by a one-time request to activate the wear assessment subsystem,
characterized in that it comprises a step of assessing a wear of the reusable containers implementing, during the assessment of the wear of one of the containers:
a production of a vibration sequence with predetermined frequency and amplitude, in a wall of one of the reusable containers;
a capture of the vibrations propagating in the wall of the container by the accelerometer to determine a captured vibration profile;
an analysis of the captured vibration profile compared to a reference vibration profile;
a recording and an issuing of a notification relating to a degradation of the captured vibration profile compared to the reference vibration profile of the container.

37. A subsystem for assessing the wear of at least one physical element constituting a device into which said subsystem is integrated,
said subsystem comprising at least one vibration sensor connected to electronic processing means and coupled to the physical element,
characterized in that the subsystem comprises:
at least one vibration generator intended to produce vibrations transmitted to said physical element, the generator being parameterized to produce a vibration sequence with at least one predetermined frequency and at least one predetermined amplitude,
and in that the electronic processing means are programmed with at least one reference vibration profile of the physical element, and are parameterized to:
periodically trigger the vibration generator, or automatically after the detection of a predetermined event detected by at least one sensor connected to the electronic processing means, or trigger the vibration generator by a one-time request to activate the wear assessment subsystem;
analyze vibrations produced by the vibration generator and captured by the vibration sensor to determine a captured vibration profile of the physical element;
issue a notification relating to a degradation of the captured vibration profile compared to the at least one reference vibration profile of the physical element.

38. The wear assessment subsystem according to claim 37, characterized in that the generator is parameterized to produce at least two vibration sequences with at least two different predetermined frequencies and/or at least two different predetermined amplitudes.

39. The wear assessment subsystem according to claim 37, characterized in that the or one of the reference vibration profiles of the physical element corresponds to a vibration profile of the physical element in new state, or in repaired state, or in transient state determined by vibration analysis at a predetermined instant.

40. The wear assessment subsystem according to claim 37, characterized in that the or one of the reference vibration profiles of the physical element corresponds to an aggregate of vibration profiles of physical elements previously analyzed by the electronic processing means.

41. The wear assessment subsystem according to claim 37, characterized in that the vibration generator is directly coupled to the physical element.

42. The wear assessment subsystem according to claim 37, characterized in that the vibration sensor is directly coupled to the physical element.

43. The wear assessment subsystem according to claim 37, characterized in that the vibration sensor is chosen from a group comprising an accelerometer, a velocimeter, a displacement sensor, a resistive strain gauge.

44. A reusable container intended to contain objects, characterized in that it forms the device comprising the physical element and the wear assessment subsystem according to claim 37.

45. The reusable container according to claim 44, characterized in that the one-time request to activate the wear assessment subsystem is issued when the container is in a reference situation.

46. The reusable container according to claim 44, characterized in that the physical element to which the vibration generator is coupled is a wall of said container.

47. The reusable container according to claim 44, characterized in that it comprises a display device intended to be visible to a user of the container, and in that the electronic processing means are parameterized to display on the display device the notification relating to a degradation of the captured vibration profile, said notification being issued by the wear assessment subsystem.

48. The reusable container according to claim 45, characterized in that it comprises a display device intended to be visible to a user of the container, and in that the electronic processing means are parameterized to display on the display device the notification relating to a degradation of the captured vibration profile, said notification being issued by the wear assessment subsystem.

49. The reusable container according to claim 46, characterized in that it comprises a display device intended to be visible to a user of the container, and in that the electronic processing means are parameterized to display on the display device the notification relating to a degradation of the captured vibration profile, said notification being issued by the wear assessment subsystem.

50. A preventive maintenance system comprising wear assessment subsystems according to claim 37, characterized in that the system comprises a remote server and, for each subsystem, means of communication with the remote server which is parameterized to record the notification relating to the degradation of the captured vibration profile by each subsystem.

51. The preventive maintenance system according to claim 50, wherein each wear assessment subsystem forms a fleet of reusable object conveying containers, and the wear assessment subsystem is integrated into a container intended to contain objects, characterized in that it forms the device comprising the physical element and the wear assessment subsystem.

52. A method for assessing the wear of at least one physical element constituting a device integrating a wear assessment subsystem which implements the method, the wear assessment subsystem comprising:
at least one vibration sensor connected to electronic processing means and coupled to the physical element;
at least one vibration generator intended to produce vibrations transmitted to said physical element, the generator being parameterized to produce a vibration sequence with at least one predetermined frequency and at least one predetermined amplitude,
the electronic processing means being programmed with at least one reference vibration profile of the physical element,
the method characterized in that it comprises the steps of:
periodically triggering the vibration generator, or automatically after the detection of a predetermined event detected by at least one sensor connected to the electronic processing means, or triggering the vibration generator by a one-time request to activate the wear assessment subsystem;
analyzing vibrations produced by the vibration generator and captured by the vibration sensor to determine a captured vibration profile of the physical element;
issuing a notification relating to a degradation of the captured vibration profile compared to the at least one reference vibration profile of the physical element.
